(19) United States
(12) Patent Application Publication
(10) Pub. No.: US 2012/0017695 A1
(43) Pub. Date: Jan. 26, 2012

(54) COMPLEX BALANCING OF A ROTATING MECHANICAL PART

(76) Inventors: José Buendia, Bourgoin Jallieu (FR); Claude Annie Perrichon, L'Isle d'Abeau (FR); François Giry, Challes les Eaux (FR); Pierre Piccaluga, Prangins (CH)

(21) Appl. No.: 13/255,735

(22) PCT Filed: Jul. 28, 2009
(86) PCT No.: PCT/FR2009/000936

§ 371 Date: Oct. 11, 2011

(30) Foreign Application Priority Data
Mar. 12, 2009 (FR) PCT/FR2009/000259

(51) Int. Cl. G01L 1/00

(52) U.S. Cl. 73/774

(57) ABSTRACT

Mechanical stresses of a tire are dynamically balanced using piezoelectric probes adjacent the tire. The piezoelectric probes are hypersensitive to electromagnetic fields and are configured to identify electronic information corresponding to mechanical stresses in the tire based on receiving a flow of electrons in an ambient space, and to transmit the electronic information in reverse phase to the tire to reduce vibrations of the tire.

### RELATED APPLICATIONS

This application filing is a very particular extension of studies carried out over the last three years for the use of the chemistry and elastic deformation effects of materials that are also stabilized by an electronic information loop. Priority is claimed in PCT publication PCT/FR2009/000259 titled Electronic Organization For Dynamic, Chemical And Mechanical Performance.

This publication provides the generality of the functions of an electronic component referred to as an eCRT probe. The eCRT probe operates based on three simultaneous activities having novel applications.

### DETAILED DESCRIPTION OF THE PREFERRED EMBODIMENTS

The medium of the application is a pertinent, but non-exhaustive, exemplary embodiment that shows perfectly the circumstances in which the present application is useful.

In FIG. 3, a wheel with a tire 5 rolls over a road 4 having an uneven or irregular profile. The wheel supports the mass 6 to be transported and the driving force is the force 2 that is exerted on the axle of the wheel in order to obtain the reaction 3 of the force advancing the tire on the road. The shock absorber 1 undergoes all the rebound reactions of the tire which acts as a balloon on the road, maintained by the mass to be transported plus the torque of the power to be transmitted by the elasticity of the tire which transfers the force from the axle of the wheel to the roadway, i.e., the driving force of the mass 6 to be transported. In short, the rolling tire transfers all the mass and power forces and accepts the deformations in the ground.

In addition, the tire must be balanced with respect to its own distribution of the masses, thereby excluding the dynamic reality as a real function which is much more complex than simple balancing. Balancing does not take account of the deformation of the tire and of its internal tensile forces between the tread and the sidewalls that transpose the power forces, the braking forces, the deformations in the road and the mass to be transported. The forces for translating the driving stability of the masses during acceleration and braking are very high tensile forces and compressive forces, which are born by the structures and the structure of the rubber compounds employed.

These tensile and compressive forces result in movements of intense magnetic charges, as does any friction of the rubber compounds on the roadway. All these forces are identified by electron fluctuations which are managed by the eCRT technology which captures, absorbs the electrons or immobilizes them or else reflects them as an inverse phase. This tends to immobilize the electrons at the source of the elastic deformations.

The electronic component undertakes the absorption of the magnetic charges by the metallic material included in the piezoelectric component, which transforms them into an electrical current and eliminates them in the form of mechanical vibrations. This is one of the features of the eCRT that we know, but which is applied differently in the specific context of the present application because of an additional stress.

The function is identical in a particular usage of the tire in action, the apparatus cleans the magnetic charge which is captured by the metal filler contained in the piezoelectric material. By introducing copper, gold, iron or metal powder into the piezo, it is possible to convert the magnetic charge into an electrical charge which is immediately transformed into mechanical movements. The metal may be in the form of small coils of a few turns in order to pick up the radial magnetic field and transform it into an electrical current.

Through experimentation, we have operated with metal powder or aluminum powder and, depending on the concentration, we raise the relatively intense piezoelectric activity by the electrical charge acquired in the powders or the loops or in both. A mini-coil with the powder allows the effects to be optimized. However, a winding operation necessitates a specific amplitude and frequency. The powder with a certain density and concentration in the mixture of the paste of the piezo makes it possible to receive much more current in terms of frequency and of amplitude, without being specially tuned. This is the case of vibration resolution and complex dynamic balancing of wheels and tires.

The powder makes it possible to have an overall holistic effect, sensitive to all the magnetic charges operating around the electronic component in the tire, less specific but generally more sensitive depending on the fields of application. The two technologies make reference to low bond energies and to van der Waals dipoles, and Laplace, Hertz, Lorentz, Gauss, Maxwell and Faraday laws. The eCRT (electron converter real time) applications show a product with multiple applications that are generated by the eCRT component, three general functions of which are indicated.

This balancing is that of naturally cleaning the excess magnetic charges appearing around and in the wheels and by the tires or in the products having undergone excess mechanical deformation stresses which are then absorbed, attracted, captured by the trap of the metal powder components contained in the piezo structure. Nanotechnology makes it possible to see the migration of electrons and associated magnetic fields, which are converted into electrical current which the piezo uses to vibrate.

These functions are all natural but, combined together, they create novel functions specific to this method. This nanotechnology vision makes it possible to solve on a large scale hitherto difficult problems by means other than conventional ones which give us complete results by novel diagnostic, identification and available energy management approaches. The complex balancing within the material, such as the rubber compounds of tires, becomes possible by the use of three functions and three actions of the added piezoelectricity of metal powder:
1. Magnetic field captured by a metal loop and/or metal powder;
2. Magnetic field transformed into electrical current; and
3. Electrical current transformed by the piezoelectric into mechanical vibration.

These three phases characterize the eCRT electronic component. The functions are instantaneous, simultaneous, and natural.

This electronic component is a novel generation of the possible treatment of the generation of self-induced currents of a mechanical nature and of an electromagnetic nature, bearing in mind that a wheel, when rolling by its aluminum or metal rim and by its radii is considered as a Barlow or Telma wheel. These electronic vibration management functions are possible as they are all based on the electronic edifice which is stressed and shaken by the mechanical stresses, and all the structures are involved, and by chemical, mechanical, fluid and gaseous stresses. In a wheel and a tire, all these electromagnetic applications are concerned. All the technical fields are in dynamic phase because the unique edifice of the material composed of electrons is involved in the functions of the mechanics, and of the gases, are concerned.

These functions stem from the use of servocontrol of the mechanical vibratory and electronic undulatory performance and relate to the use of mechanics, solids, fluids and gases. It involves the active actors, like mechanical ones, and equally the transported or transformed objects being reservoirs of passive electron charges. All industrialization is concerned by the circulation of electrons agitated by mechanical actions under multiple stresses, which tires or vehicle suspensions represent, for example.

In the eCRT automatic servocontrol, one function is to combat any electron accumulation generated by all the mechanical stresses. The eCRT tendency is to stop this electromagnetic fluctuation resulting from the deformation of the rubber compounds by the mechanical stresses and the friction of the road. This is done by stabilizing the fluctuating electronic state. The eCRT thereby stabilizes the constant, fluid-rendered movement states of the material and the dynamic conditions that the moving mechanical parts, such as the tires and wheels undergo, and become harmonious without any vibration.

The build-up of a certain electrical potential, which varies depending on the driving, the mass of the vehicle and the road, is discharged, and absorbed by the eCRT. This tends toward a stabilized potential, which constitutes the essential point of automatic servocontrol of the balancing of the wheels by this eCRT apparatus having three instantaneous functions. The balancing potential is, in this application, complex, instantaneous, and is performed on all the interacting forces.

Finally, this stabilization is an excellent approach to the various stopped and regulated agitations. The highly reactive eCRT blocks the natural activities of the electrons as soon as they arise, thereby definitively stopping any vibratory movement and of associated electrons fleeing the movements. Lenz's law keeps the structure of the tires stable. This overall stabilization effect of the forces, and not only that of the balancing of the mass of the tire, is obtained by including the free eCRT apparatus in the inside of the tire when mounted on the rim, without thereafter performing conventional balancing of external mass.

This natural reactivity of absorbing the electromagnetic charges and also this eCRT counter-reactivity action to each of the forces generated on the tire can be exerted only if there is a reference memory of a known state which serves as reference for the stable condition. Without memory, there would be no reactivity exactly proportional, in an inverse phase, to the intensities and amplitudes of the imposed mechanical forces which finally, for the same reasons, are automatically stabilized.

This is because the initial aim of the electrons was to oppose the movements of mechanical stresses, which by means of the eCRT becomes effective and is a mechanical self-management of the calmed deleterious effects of all the attacks by the mechanical stresses. The result is an absence of rolling noise and absolute comfort, which erases all the tensile forces and agitation forces while the vehicle is running.

This first mode of regulating the balancing which is solved with the eCRT is that of the elastic deformation of the materials where the migration of the electrons is greatly attenuated, making the tires stable, and here a purely mechanical second stress occurs, which is to be resolved which is the modification of the radius of the tread (FIG. 2). This second mechanical stress is the periodic deformation of the tire 5 in contact with the road 4. A wheel 7 with a tire 10 rotates about a radius 20 that becomes a smaller radius 40, thereby causing at each revolution of the wheel a shock on the eCRT apparatus 50, and which jumps at each passage.

An attenuation of the shock wave, upon reduction in the radius as the eCRT passes over the ground, is obtained using an encapsulation made of silicone gel that accepts the deformation and the passage of the modified eCRT 50 without damage. The silicone gel encapsulation absorbs the difference in radius. This problem also solves the passage over bumps on uneven roads. The wheel, moved by the rim 7, rotates in a desired direction 60.

There are two mechanical stresses to respond. On the one hand there is the overall forces due to the traction, braking and mass of the vehicle and to the profile of the road. On the other hand, there is the partial predictable periodic deformation of the tire on the road. The eCRT is mounted in a very elastic encapsulant, contained in a pouch or envelope made of a very soft rubber polymer or even an impermeable fabric, so as to absorb the elastic deformation of the tire along the radius 40. The radius 40 represents overall the contact sector of the wheel via which the road-holding and accelerating or braking forces are transferred.

Sachets or envelpoes of silicas are placed in truck tires for balancing, but this remains very insufficient because of absence of management of the electromagnetic and mechanical stresses of the periodic effects which endlessly reject the sachets. This is even when being inert because of their structuring in sand, with no rebound effect.

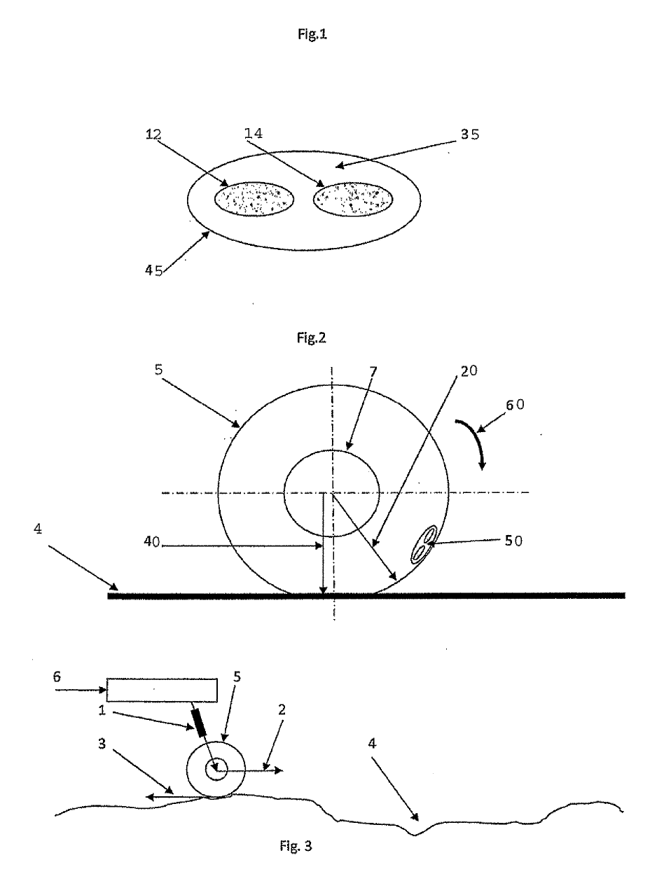

Our arrangement of the present method takes the example of an egg which, when it is not cooked, absorbs any type of vibration by a density-differentiated double structure, represented by the yolk and the white of the egg. FIG. 1 shows a non-exhaustive embodiment of the method for the complex balancing of a wheel that includes many notions of actual mechanical stresses, which are never addressed. The shell keeping the two structures together, like the very flexible envelope 45, which encapsulates the silicone 35, or the envelope where the silicone is molded, which itself molds the two illustrated eCRTs 12, 14. There are two eCRTs in order to distribute the shock deformation forces.

It would have been possible to fit five eCRT balls. This arrangement makes it possible to dissipate the regular shock waves, which increase with speed, that the rolling of the tire on the road causes. The shocks break the solid structures of the piezoelectricity, structures of which are all crystalline, and therefore are brittle and would break.

The apparatus thus consists of two components, one rigid—the piezoelectric structure eCRT—and the other a very soft, or amorphous, paste structure, made of any type of polymer, which makes it possible for complex balancing problems to be fully solved. The balancing problems are mechanical force interactions that generate electron fluctuations according to stable and known relationships, elastic deformations of the materials and piezoelectric effects.

In the field of traditional mechanics, which in reality focuses on the same structure and a measurement, wherein the other functions of the same structure that serve for several simultaneous functions are forgotten. In regards to the apparatus, the envelope must, while still being flexible in this case, be able to be housed where the vibrations are strongest. This is because the apparatus is free in the tire. The results in terms of comfort are surprising.

Tests show that the driver of the vehicle is no longer subjected to the tire vibrations and experiences silent, fluid and almost effortless driving. Indeed, all the opposing mechanical stresses are greatly reduced, thereby freeing the steering wheel therefrom, reducing noise and providing unexpected comfort. The elastic balloon that forms the jumping tire is no longer subject to alternations of uncontrolled movements and really grips the road. It is quite clear that driving in the rain is excellent and that braking and safety are greatly improved.

The fatigue threshold is greatly delayed. Different applications involving complex problems in mechanics or hydraulics on industrial machines or engines may find, thanks to this method, reliable solutions and more stable operation. This method is one for self-stabilizing complex stresses, of a kinetic mechanical order or for management of gases and liquids in the industrial world. This novel self-regulating technique demonstrated by nanotechnology is a great step forward in addressing known problems that have remained without a true solution, or problems that were seen only from a static standpoint, in which only one factor was taken into account.

The apparatus has a weight of 50 grams for a piezo value with 30 grams of active components. The values are lower for a motorcycle, a small car or a bicycle. Applications on helicopters may be solved with sensitive stations or be diagnosed by the measurement of the roaming electrons following large mechanical stresses which agitate them, by specific elastic deformations.

1-5. (canceled)

6. A method for dynamically balancing mechanical stresses in a tire identified by flows of electrons, the method comprising:
positioning at least one piezoelectric probe adjacent the tire, the at least one piezoelectric probe configured to
identify electronic information corresponding to mechanical stresses in the tire based on receiving the flows of electrons in an adjacent space, and
transmit the electronic information in reverse phase to the tire to reduce vibrations of the tire.

7. The method according to claim 6, wherein the at least one piezoelectric probe is placed directly inside the tire.

8. The method according to claim 6, wherein the at least one piezoelectric probe is encapsulated.

9. The method according to claim 6, wherein the at least one piezoelectric probe is molded in a soft paste.

10. The method according to claim 9, wherein the soft paste comprises a silicon gel.

11. The method according to claim 6, wherein the at least one piezoelectric probe is based on nanotechnology.

12. The method according to claim 6, wherein the at least one piezoelectric probe weighs about 50 grams or less.

13. The method according to claim 6, wherein the at least one piezoelectric probe detects and corrects at least one of asymmetric and parasitic movement of electrons in the tire.

14. The method according to claim 6, wherein the at least one piezoelectric probe comprises at least one of quartz and silica, and further comprises a metallic powder.

15. The method according to claim 14, wherein the metallic powder comprises at least one of copper, gold and iron.

16. The method according to claim 6, wherein the at least one piezoelectric probe comprises a pair of spaced apart piezoelectric probes.

17. An apparatus for dynamically managing mechanical stresses of a tire, the appliance comprising:
at least one piezoelectric probe adjacent the tire, and configured to
identify electronic information corresponding to mechanical stresses in the tire based on receiving a flow of electrons in an adjacent space, and
transmit the electronic information in reverse phase to the tire to reduce vibrations of the tire.

18. The apparatus according to claim 17, wherein said at least one piezoelectric probe is placed directly inside the tire.

19. The apparatus according to claim 17, wherein said at least one piezoelectric probe is encapsulated.

20. The apparatus according to claim 17, wherein said at least one piezoelectric probe is molded in a soft paste.

21. The apparatus according to claim 20, wherein the soft paste comprises a silicon gel.

22. The apparatus according to claim 17, wherein said at least one piezoelectric probe is based on nanotechnology.

23. The apparatus according to claim 17, wherein said at least one piezoelectric probe weighs about 50 grams or less.

24. The apparatus according to claim 17, wherein said at least one piezoelectric probe detects and corrects at least one of asymmetric and parasitic movement of electrons in the tire.

25. The apparatus according to claim 17, wherein said at least one piezoelectric probe comprises at least one of quartz and silica, and further comprises a metallic powder.

26. The apparatus according to claim 25, wherein the metallic powder comprises at least one of copper, gold and iron.

27. The apparatus according to claim 17, wherein said at least one piezoelectric probe comprises a pair of spaced apart piezoelectric probes.
